(19) United States
(12) Patent Application Publication
(10) Pub. No.: US 2018/0125060 A1
(43) Pub. Date: May 10, 2018

(54) Articles of Manufacture And Related Methods To Create Insect Barriers

(71) Applicant: Seashell Technology, LLC, La Jolla, CA (US)

(72) Inventors: James Glass, Cardiff By The Sea, CA (US); David Schultz, La Jolla, CA (US)

(73) Assignee: Seashell Technology, LLC, La Jolla, CA (US)

(21) Appl. No.: 15/803,811

(22) Filed: Nov. 5, 2017

Related U.S. Application Data
(60) Provisional application No. 62/418,254, filed on Nov. 6, 2016.

(51) Int. Cl. A01M 29/34; A01M 1/20; C09D 1/00

(52) U.S. Cl. CPC A01M 29/34; C09D 1/00; A01M 1/2011

(57) ABSTRACT

Embodiments of the present invention are directed, inter alia, to novel methods for producing substrates and articles of manufacture that possess a passive barrier to the passage of crawling insects and the related substrates and articles of manufacture. An exemplary article of manufacture can be a pet food bowl, a pet food container, a kitchen cupboard, a trash receptacle, a garbage receptacle, a foundation of a structure, a bee hive, a bird feeder, a plate, a bowl or a pedestal suitable for cake, cupcakes or other food item. The crawling insects can be, for example, an ant (leaf eater, Argentine, carpenter, pharaoh, fire), a spider, a cockroach, a bed bug, termites, an aphid, an arthropod, a tick, a flea, a silver fish, a thrip, a gnat, an aphid, a Japanese beetle, a beetle (potato and bean), a flea beetle, a fleahopper, a squash bug, a slug, a leaf hopper, a harlequin bug, a milk weed bug, a mite, a louse, a scorpion, a millipede, a centipede or a gypsy moth.

### CROSS REFERENCE TO RELATED APPLICATIONS

This application claims the benefit of U.S. Provisional Patent Application Ser. No. 62/418,254, filed on Nov. 6, 2016; herein incorporated by reference for any and all purposes.

### STATEMENT REGARDING FEDERALLY SPONSORED RESEARCH OR DEVELOPMENT

None

The section headings used herein are for organizational purposes only and should not be construed as limiting the subject matter described in any way.

### BRIEF DESCRIPTION OF DRAWINGS

The skilled artisan will understand that the drawings, described below, are for illustration purposes only. The drawings are not intended to limit the scope of the present teaching in any way.

In the drawings, the sizes and relative positions of elements in the drawings are not necessarily drawn to scale. For example, the shapes of various elements and angles may not be drawn to scale, and some of these elements may be arbitrarily enlarged and positioned to improve drawing legibility. Further, the particular shapes of the elements as drawn may not be intended to convey any information regarding the actual shape of the particular elements, and may have been selected solely for ease of recognition in the drawings.

FIG. 1 is a photograph of three (3) baited cardboard pieces, each comprising a different surface or coating that ants (and other crawling insects) must traverse to reach the bait placed at the top of the cardboard piece.

FIG. 2 is a photograph of two (2) baited wood platforms raised by a pedestal, each comprising a different surface or coating that ants (and other crawling insects) must traverse to reach the bait placed on the pedestal.

FIG. 3 is a photograph of two (2) nylon wrapped glass vials, each comprising a different surface or coating that ants (and other crawling insects) must traverse to reach the bait placed at the top of the glass vial.

FIG. 4 is a photograph of four (4) paper plates, each comprising a different surface or coating on the underside of the plate that ants (and other crawling insects) must traverse to reach the bait placed on the topside of the plate

FIG. 5 is a photograph of four (4) plastic cups turned upside down, each comprising a different surface or coating that ants (and other crawling insects) must traverse to reach the bait placed on top of the bottom of the inverted cup.

FIG. 6 is a photograph of three (3) plastic substrates placed at an inclined angle to horizontal, each comprising a different surface or coating that ants (and other crawling insects) must traverse to reach the bait placed at the top of the substrate.

FIG. 7 is a photograph of four (4) cardboard substrates that form a pedestal, each comprising a different surface or coating that ants (and other crawling insects) must traverse to reach the bait placed on top of the bottom of the pedestal.

FIG. 8 is a photograph of two (2) different aluminum panels on which a water-soluble dye solution was placed and allowed to air dry. One panel was further coated to prevent extraction of the water-soluble dye by subsequent exposure to water.

FIG. 9 is a photograph of two glass vials wrapped with a polyvinylidene film, each comprising a different surface that ants (and other crawling insects) must traverse to reach the bait placed at the top of the substrate.

FIG. 10 is a photograph of a dog food bowl with two compartments, each comprising a different outer bottom and center divider surface that ants (and other crawling insects) must traverse to reach the bait placed inside the compartments.

All literature and similar materials cited in this application, including but not limited to patents, patent applications, articles, books and treatises, regardless of the format of such literature or similar material, are expressly incorporated by reference herein in their entirety for any and all purposes.

### DESCRIPTION

### 1. FIELD

The present invention pertains to the field of barriers to crawling insects wherein ‘crawling insects’ refers to any member of the Insecta class, Arachnida class or Myriapod subphylum of animals whose primary mode of movement is crawling during at least one stage in its lifecycle; and only during the stage or stages of the insect lifecycle where the insect's primary mode of locomotion is crawling.

### 2. INTRODUCTION

Insect infestation of the human environment has been a chronic problem of human civilization and the crawling insects with which this invention is concerned are those which are pests or nuisances to man. These include, for example, cockroaches, spiders, bedbugs, flies, moths, termites and aphids which are often offensive in appearance and may carry and spread disease; and, perhaps the most widespread of this general group of infesting insects, the ant. There are many different types of ants including the leaf cutter, Argentine, carpenter and pharaoh ants, and, of course, the highly aggressive and destructive fire ant. Since fire ants seem to be attracted to electrical devices because of the magnetic field created by the alternating current and perhaps, by the heat generated by the devices, swarming infestation can cause breakdowns of the insulation and destroy the electrical operation of a device. As a result, oilfield equipment, air conditioners and electrical-control panels are particularly vulnerable and often expensively damaged. Foraging fire ants are known to destroy young citrus trees, growing crops, and germinating seeds. This has a significant economic impact in infested areas. Fire ants can also excavate large areas of soils from under roadways, railways or bridges leading to potential infrastructure damage. Additionally, leaf-cutting ant species can rapidly defoliate citrus trees causing significant economic loss. Ants are also readily attracted to different foods and can rapidly contaminate food sources that are left susceptible.

Numerous strategies have been devised to kill or repel crawling insects and ants (See for example: U.S. Pat. No. 4,874,611, U.S. Pat. No. 5,589,181, U.S. Pat. No. 5,177,107 and U.S. Pat. No. 8,359,784). Most of these approaches are chemical based and are hazardous, posing a threat to humans, birds and animals. Chronic treatment with pesticides can also lead to the development of resistant strains of targeted insects. There also is a benefit to the environment in reducing the use of insecticides, and developing non-toxic solutions for controlling insects. Non-toxic effective solutions are desired, such as a non-toxic reagent which could repel, or keep crawling insects from invading a particular area or object.

One approach to keep insects away from their desired target is to place a physical barrier around an area to be protected from infestation. There are examples where devices have been created that incorporate a moat that is filled with a liquid to prevent the insects from traversing that surface. These include tables (See for example: US Pat. No. 7, 946,230) and a variety of animal food bowls, plates and dishes (See for example: U.S. Pat. No. 6,125,790; U.S. Pat. No. 6,860,229; and U.S. Pat. No. 7,219,622). These devices often require continual maintenance as the liquid can evaporate and require the manufacture of specific device configurations.

Alternatively, collar type barriers have been described that can be placed around, for example, a tree truck or bird feeder holder to prevent the insects from crawling across the surface to get to the desired target. These include collars that present a physical barrier (See for example: U.S. Pat. No. 6,553,726), impregnated with an insecticide/repellent (See for example: U.S. Pat. Application 20100005713) or coated with an adhesive substance to trap the insects (See for example: U.S. Pat. Application 20150366192, and U.S. Pat. No. 7,793,461). These types of devices are limited in usefulness since they have to be physically and properly attached to the tree trunks which often have a non-smooth surface leading to defects in the uniformity of the collar barrier. The environmentally unfriendly insecticides or the adhesive also can become depleted over time when exposed to the elements and lose effectiveness. Devices using electrical pulse to dislodge or trigger traps have been described (See for example: U.S. Pat. No. 4,423,564; and U.S. Pat. No. 5,557,879) but these require a power source and are limited in general applicability.

There has been an active area of investigation to determine the mechanism of adhesion and barriers to adhesion of a variety of different types of crawling insects. These studies have revealed that the surface topology of a substrate can affect the ability of insects to gain traction and traverse across a surface. This research was initiated by observations that certain plants surfaces can be barriers to crawling insects. Prüm et. al. (2013) described making a replica of a plant surface that leaf beetles could not adhere to. Other workers assessing insect adhesion to microfabricated pillars (See for example: Zhou et. al. 2014), rough aluminum oxide membranes (See for example: Gorb et. al 2010), sandpapers of various roughness (See for example: Bollock and Federle 2011), epoxy resin substrates (See for example: Voight at. al. 2008, Wolff and Gorb, 2012) and wax coatings prepared by thermal evaporation (See for example: Gorb et. al. 2014) have demonstrated that particles and surface features with diameters and height ranging from 0.2-10 microns can all inhibit insect adhesion. These studies all used pre-fabricated materials and/or casting techniques to create the test substrate.

There are other examples on the development of particle based barriers for insects which include devices containing talcum powders (See for example: U.S. Pat. Appl. No. 20040062784 and U.S. Pat. No. 9,253,973) or avalanche-type devices in which the insects slip on loose particles (See for example: U.S. Pat. No. 4,263,740). However, these types of treatments are rapidly depleted and can be destroyed by exposure to rain or wind.

In an alternative approach, smooth surfaces have been used as barriers to prevent traction by the insect's claws (See for example: U.S. Pat. No. 6,223,463; U.S. Pat. No. 9,144,233 and U.S. Pat. No. 9,253,973). These require the fabrication of a specific device, and function more as a trap than as a barrier that could be easily applied to a variety of substrates. Long (See for example: U.S. Pat. No. 5,392,559; U.S. Pat. No. 5,414,954; U.S. Pat. No. 5,561,941 and U.S. Pat. No. 5,566,500) have described surfaces coated with fluorocarbon (PTFE) particles to prevent the movement of crawling insects. These aqueous-based, surfactant containing coating formulations with particle sizes ranging from 0.5-5 micron in diameter have been applied to glass and aluminum and are effective on these smooth surfaces at greater than 15 weight percent (wt %). On a roughened surface such as rock, 60 wt % coating formulations were required to be effective and are prone to cracking and delamination. A high wt % PTFE aqueous-based dispersion is commercially sold under the tradenames Fluon or Insect-a-slip and is used for coating smooth glass and plastic surfaces to prevent ants from escaping their habitats. These PTFE particle-based formulations, however, require high wt %, are expensive and introduce undesirable fluorocarbons into the environment.

Sekutowski et. al. (U.S. Pat. No. 6,464,995) developed a particulate-based membrane coating for treating horticultural substrates to protect from infectious diseases, insects or environmental stresses. The plant trunk substrates are treated with aqueous based solutions containing particulate materials consisting of 1-10-micron diameter calcium carbonate, hydrous kaolin, calcined kaolin and mixtures thereof to create a barrier to disease penetration and environmental damage. The ability of insects to crawl on these surfaces was not described or evaluated.

In contrast, Orchard (2012) prepared a silica particle based formulation for coating smooth glass substrates surfaces. These coatings could prohibit ant movement on inclined coated glass surfaces. This work also concluded that surface energy was not important to prevent insect movement across a roughened surface.

### 3. DEFINITIONS

For the purposes of interpreting this specification, the following definitions will apply and whenever appropriate, terms used in the singular will also include the plural and vice versa. In the event that any definition set forth below conflicts with the usage of that word in any other document, the definition set forth below shall always control for purposes of interpreting the scope and intent of this specification and its associated claims.

Notwithstanding the foregoing, the scope and meaning of any document incorporated herein by reference should not be altered by the definition presented below. Rather, said incorporated document should be interpreted as it would be by the ordinary practitioner based on its content and disclosure and then interpreted with respect to how it relates to the content of the description provided herein.

The use of “or” means “and/or” unless stated otherwise or where the use of “and/or” is clearly inappropriate. The use of “a” means “one or more” unless stated otherwise or where the use of “one or more” is clearly inappropriate. The use of “comprise”, “comprises”, “comprising”, “include”, “includes”, and “including” are interchangeable and not intended to be limiting. Furthermore, where the description of one or more embodiments uses the term “comprising”, those skilled in the art would understand that in some specific instances, the embodiment or embodiments can be alternatively described using language “consisting essentially of” and/or “consisting of”.

As used herein, “coating” refers to a covering that is applied to a surface or substrate.

As used herein, “thy coating” refers to a coating that is not sticky, wet or moist to the touch.

As used herein, a “coating formulation” refers to a mixture of reagents that when combined and applied to a surface produces a ‘passive barrier’ to crawling insects.

As used herein, “on” with reference to a surface or substrate is not intended to imply direct physical contact with said surface or substrate. Rather, to say that a coating or dry coating is ‘on’ a surface or substrate refers to said coating being directly or indirectly (e.g. by contacting one or more intervening layer(s) of material) above and in contact with said surface or substrate, for example, by placement on top of other layers of coatings one or more of which can be in direct contact with said surface.

As used herein, “passive barrier” refers to a barrier that is fixed spatially.

As used herein, “substrate” refers to a base material. Substrates used in the practice of this invention can include, but are not limited to, concrete, wood, paint, metal, ceramic, paper, cardboard, tree bark, particle board, rubber, polytetrafluoroethylene, stone, fabric, nylon, stucco, plaster, drywall composite or a combination of any two or more of the foregoing. In some embodiments, the substrate can be plastic. The substrate can also be the foundation of a building or structure.

As used herein, “superhydrophobic coating” refers to a coating comprising superhydrophobic components that when applied to a surface produces a superhydrophobic surface. A “superhydrophobic surface” is any surface that produces a water drop contact angle of greater than 150 degrees. See: Simpson, S T, Hunter, S R, Aytug, T. Superhydrophobic Materials and Coatings: a review, Reports on Progress in Physics (2015) 78: 086501.

As used herein, “surface” refers to the outer boundary or interface of a coating or substrate (as applicable).

### 4. GENERAL

It is to be understood that the discussion set forth below in this “General” section can pertain to some, or to all, of the various embodiments of the invention described herein.

This invention generally relates to methods for creating barriers to crawling insects which can be prepared by application of a coating formulation to a surface. The coating formulation can be comprised of at least one solvent and at least one dispersed fumed silica that forms a mixture that can, inter alia, be applied to a surface using spray, paint or dip coating methods. After solvent evaporation, a dry coating of fumed silica particles forms a layer having topological and chemical properties that prevent insects from traversing the coating when the insect must traverse an incline to cross the passive barrier. In some embodiments, the coating can be created using a hydrophobic fumed silica which can result in a coating that can be superhydrophobic and repel water. This type of coating can be useful to create an insect barrier that is weather resistant.

As noted above, the passive barrier can be formed using a mixture comprising at least one fumed silica. Fumed silicas are commercially available from numerous sources such as Evonik and Cabot. Fumed silica (CAS number 112945-52-5), also known as pyrogenic silica because it is produced in a flame, consists of microscopic droplets of amorphous silica fused into branched, chainlike, three-dimensional secondary particles which then agglomerate. The resulting powder has an extremely low bulk density and high surface area. The surface area of fumed silica can range from 10-400 m²/gram. Fumed silicas are defined primarily into two classifications related to their surface chemical properties; either, hydrophobic or hydrophilic. These materials are commercially available with tradenames such as Aerosil or Cab-O-Sil. A non-comprehensive list of hydrophobic fumed silicas includes Aerosil R208, Aerosil R104, Aerosil R202, Aerosil R805 and a non-comprehensive list of hydrophilic fumed silicas include Aerosil 130, Aerosil 200, Aerosil 255 and Aerosil 300. Any of the foregoing, alone or in combination, can be used in practice of various embodiments of this invention.

Generally, this invention can be practiced with any solvent (or combination of solvents) that when mixed with the one or more fumed silicas produces a liquid mixture that can be applied by spray, paint or dip coating methods to a surface to produce a coating that is suitable to form a passive barrier to crawling insects. Generally, the solvent or solvents can be selected such that they evaporate quickly to form a dry coating but that is not a definite requirement. Rapid evaporation at ambient temperature is desirable because it limits dripping during application and cracking of the coating during drying. Generally speaking, the solvent should be suitable to form a suspension of fumed silica at a weight percent of less than 15% of the weight/volume ratio (weight of fumed silica to the total volume of solvent used in the mixture) of the mixture in a form that can be used in spray, paint or dip coating methods. Some exemplary solvents that can be used to create a coating formulation suitable for use in practice of this invention can include, but are not limited to, water, ethanol, methanol, isopropanol, acetone, cyclohexane, toluene, methyl acetate, methyl ethyl ketone, ethyl acetate, mineral spirits or a combination of any two or more of the foregoing.

Generally, the ‘passive barrier’ created with a coating applied to a surface can take any practical form. The form of the passive barrier will generally be selected based on the application. For example, the size, width, location and two-dimensional or three-dimensional structure of the passive barrier will generally (but not necessarily) be different for plates being used to keep ants away from food as compared with, for example, a barrier used to keep ants from crawling up a tree. In some respects, the only limitation on form (including size: length, width and/or depth) of the barrier is the limitations on the form of the substrate on which the coating is to be applied and as incorporated into an article of manufacture in a manner that inhibits or prevents crawling insects from traversing the barrier. Notwithstanding the foregoing, it is also to be kept in mind that the location and size of the passive barrier is intended to be sited such that the crawling insects encounter an angle of incline (to horizontal) when attempting to cross said passive barrier. The diversity of the aspects of a passive barrier can be further illustrated by the following non-limiting examples.

### EXAMPLE 1

### Pet Food Bowl or Container

A pet food bowl can be made insect resistant by applying the coating formulation around the entire outer side of the bowl thereby creating a continuous barrier around the entire circumference of the bowl. Alternatively, a portion of the outer side of the bowl can be coated, where the width of the applied coating is preferably (but not necessarily) greater than 1 cm and covers the entire circumference of the outer side of the bowl. As previously noted, the coating formulation should be applied to an inclined surface of the pet bowl (with reference to when the bowl is placed for its intended use) so that crawling insects are unable to traverse the applied coating to reach the pet food.

### EXAMPLE 2

### Trash Can or Garbage Container

It is a frequent occurrence (and nuisance) that ants are attracted to, find and infest trash cans or garbage containers. To prevent this ant invasion, a trash can or garbage container can be made ant resistant by applying the coating around the entire inclined outside of the trash can or garbage container (with reference to when the bowl is placed for its intended use) creating a continuous barrier surrounding the circumference of the container. In other embodiments, it is also possible to coat just some of the outside of the inclined surface of the container or can—but around the entire circumference of the container of can. For example, the inclined or vertical width of the coating should preferably (but not necessarily) be greater than 1 cm and can be placed anywhere on (but completely around the circumference of) the inclined outer surface of the trash can or garbage container so that crawling insects are unable to traverse the applied coating to reach the trash/garbage.

Alternatively, if the trash can or container has a tight-fitting lid, then the underside of the vertical or inclined lip of the trash can or garbage container could be modified with the coating. In this case, if an ant or insect attempts to transverse the coated inclined surface it would be walking/crawling upside down. Because the ant needs to walk upside down (which, for purposes of this invention, is considered to be an incline to horizontal) then the width of the barrier coating need not be too wide (preferably, but not necessarily, greater than 0.5 cm), as the force of gravity on the weight of the insect makes it even more difficult to move without falling off the surface.

### EXAMPLE 3

### Tree or Plant Protection

Infestation of trees or plants by numerous different types of crawling insects are known to cause large economic losses to agriculture. A few examples of insects that can carry disease and damage foliage or crops are aphids, ants and white flies. Plants, trees, crops and flowers can be protected from crawling insects by applying the coating around the entire side of the tree trunk or stem of the plant creating a continuous barrier between the ground and the leaves. The width of the coating on the trunk or stem should preferably (but not necessarily) be greater than 1 cm and can be placed anywhere on an inclined surface of the tree trunk below the first set of branches or leaves. The coating can be applied directly to the tree trunk or stem of the plant, or alternatively, a strip of material can be wrapped or fixed tightly around the plant stem or tree trunk, where such strip of material is either pre- or post-treated with the coating formulation that forms the passive barrier.

### EXAMPLE 4

### Paper Goods

A common complaint during a picnic or outdoor gathering is the appearance of ants and other insects, which rapidly results in their finding and invading any available food or drink items. Papers goods, including plates, bowls, platters, cups and boxes, used for food handling, and as may be used during a picnic, can be made insect resistant by applying the barrier around the entire side of the bowls, cups or boxes. For some items, such as a food plate, the entire underside of the plate could be coated to thereby form a passive barrier to the entire underside of the plate.

Alternatively, coating only part of the item may be effective. For example, the width of a coating applied on the inclined sides (with reference to when the item is placed for its intended use) of such item should preferably (but not necessarily) be greater than 1 cm and can be placed anywhere on the outside of the bowl, cup or box so that there is a continuous barrier between the bottom and top of the item. For example, in the case of a plate or platter, a 1 cm wide complete ring of the crawling insect barrier coating can be applied to around the bottom underside of the plate or platter. The barrier ring preferably should be on the part of the plate that does not touch the surface on which the plate or platter is sitting nor will it be in contact with food items placed on top of the plate or platter. If the coating is applied to an underhanging surface of the plate or platter, when positioned for normal use, then the width of the coating can be less wide (preferably greater than 0.5 cm) because the insects must crawl upside down (or essentially upside down) to reach the food.

### EXAMPLE 5

### Bird Feeder

A well-known problem that can be encountered when using bird feeders (especially ones that dispense nectar) is their infestation by ants. This ant infestation can be prevented by applying a continuous barrier coating around the inclined support base, or inclined hanging support, for the bird feeder. The width of the barrier coating on the inclined surface can preferably (but not necessarily) be greater than 1 cm and can be positioned anywhere on the inclined support base or hanging support so that ants cannot reach the nectar.

### EXAMPLE 6

### Beehive

Infestation of beehives by ants and other insects can have adverse effects on the health of the bee colony resulting in a loss of honey production and recovery. An insect resistant beehive can be created by applying a continuous barrier coating around the inclined portions of the support base for the beehive. The width of the coating on the inclined surface can preferably (but not necessarily) be greater than 1 cm and can be positioned anywhere on the support base such that it forms a continuous barrier between the ground and the bee hive. Preferably, the coating should be applied on both the inside and outside of the inclined portions of the base to create a complete barrier to insects attempting to reach the hive.

### EXAMPLE 7

### Barbeque

The food, grease and drippings generated during and after barbequing are a strong attractant for ants, and their appearance is a frequently encountered nuisance. An insect resistant barbeque can be created by applying a continuous barrier coating around the inclined support base for the barbeque. The width of the coating should preferably (but not necessarily) be greater than 1 cm and can be positioned anywhere on the inclined support base below the barbeque grill. The preferred location of the barrier coating will depend on the specific barbeque design. The coating should be applied to both the inside and outside of the inclined support base to create a complete continuous barrier between the ground and the barbeque grill so that insects cannot reach the barbeque grill.

### EXAMPLE 8

### Fabrics

Many people and pets are bothered by insect crawling or biting them while working or playing outside. Examples, include construction workers, farmers, hikers, plumbers, electricians, gardeners, campers, outdoorsman, athletes, or picnickers. Fabrics incorporated into shoes, gators, socks, pants, shirts, jackets, hats etc. that are pre- or post-treated following manufacture of the items with the insect resistant barrier could limit access of the insects to human skin or pet fur. Insect resistant fabrics can be created by applying the coating to all or portions of the fabric that comprise the item so that the insect is prevented from reaching the skin or fur. For example, the cuffs of a pair of pants could be coated or the sides of a shoe can be coated so that the insect cannot climb up from the ground and traverse the shoe or pants cuff to reach the skin of the human. The coating could be applied to make a continuous barrier with a width preferably (but not necessarily) greater than 1 cm on areas of the fabric that have an incline of at least 20 degrees to the horizontal plane for some portion of time during normal use.

### EXAMPLE 9

### Tape

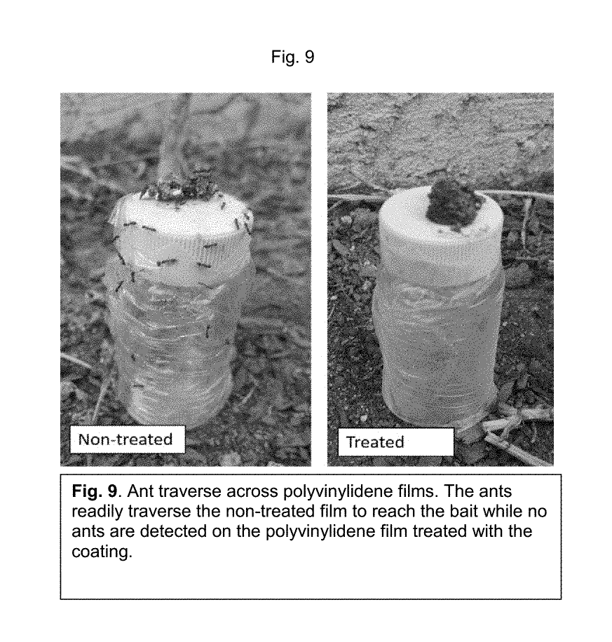

An insect proof tape can be prepared by modifying the tape surface with preferably a greater than 1 cm wide continuous crawling insect barrier coating. The tape could then be stuck to any surface that has an incline of at least 20 degrees to the horizontal plane to create the barrier to crawling insects. As example, the tape can be duct tape, aluminum tape, or other materials that can be wrapped or adhered to a substrate. In a similar manner, as an alternative to a tape, a film material can be used. An example, is shown in FIG. 9. The backside of the tape or film can have a standard adhesive for attachment, can be a Velcro type adhesive, or can utilize some other type of mechanism for adhering the tape or film to a substrate. Such a tape or film could be used to prepare passive barriers on essentially any article of manufacture by just positioning the tape or film to the article in a way that prevents crawling insects from traversing the tape or film.

As discussed, in embodiments of this invention, the passive barrier will be sited so that the crawling insects must crawl up an incline while traversing the passive barrier to get to their target. Forcing them to crawl up an incline brings gravity to bear on the crawling insect as it attempts to traverse the passive barrier. The greater the degree of incline, the greater degree of difficulty the insect will experience when crossing the passive barrier. With respect to the angle of incline, as used herein, zero degrees is horizontal. A ninety-degree incline is perpendicular to horizontal. The degree of incline can then increase to 180 degrees which is completely upside down but parallel to horizontal. Between 90 degrees and up to 180 degrees, the crawling insect begins crawling at an angle that is upside down.

### EXAMPLE 10

### Water Leachable Compounds

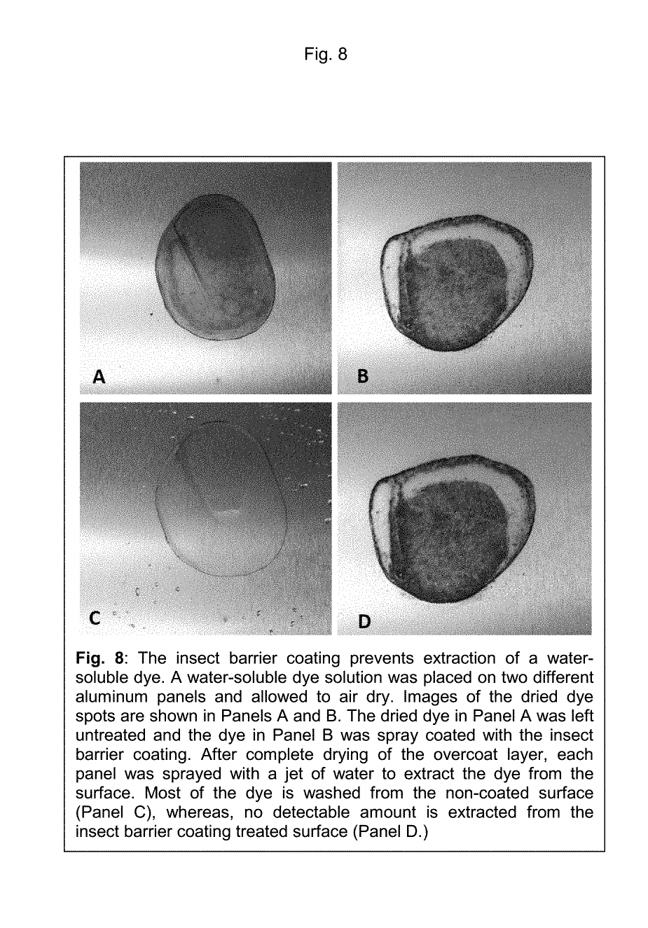

The coating can be created using a hydrophobic fumed silica which can result in a coating that will be superhydrophobic and repel water. Thus, an insect barrier coating can be created that is weather resistant and impermeable to water limiting contact between water and the underlying substrate. This function of the coating is demonstrated by the images shown in FIG. 8. In this example, the coating minimizes and/or prevents leaching and extraction of chemicals (e.g. a water-soluble dye) from the underlying substrate during exposure to water. The practical outcome of this function for the insect barrier coating would be to prevent the traverse of ants across a surface, while simultaneously minimizing or preventing a chemical (e.g. an insecticide or pesticide) from leaching from the substrate during water exposure. Thus, by overcoating with the insect barrier coating the useful lifetime of the chemical (e.g. the insecticide or pesticide) can be extended, there can be a reduction of insecticide/pesticide build-up in rain water runoff, and insecticide/pesticide can be applied to a greater range of substrates without concern that it will readily wash away when exposed to water. So that the insects have sufficient exposure time to the pesticide for it to be effective, the insecticide/pesticide and coating can be applied to substrates which are placed at any angle, including horizontal.

### 5. VARIOUS EMBODIMENTS OF THE INVENTION

It should be understood that the order of steps or order for performing certain actions (e.g. the addition of reactants) is immaterial so long as the present teachings remain operable or unless otherwise specified. Moreover, in some embodiments, two or more steps or actions can be conducted simultaneously so long as the present teachings remain operable or unless otherwise specified.

In some embodiments, this invention relates to a method comprising: a) creating a passive barrier to the passage of crawling insects comprising forming a dry coating on a substrate by applying a suspension of fumed silica in a solvent to said substrate; wherein, i) the weight (wt) of fumed silica to volume (vol) of solvent is less than 15% wt/vol; and ii) said substrate is not glass; and b) arranging said substrate such that the coating has an incline of at least 20 degrees to the horizontal plane. In the above described method, either of steps (a) or (b) can be performed before the other or simultaneously.

This invention can also be directed to a method comprising: a) applying a suspension comprising fumed silica in a solvent to a substrate of an article of manufacture to form a passive barrier to the passage of crawling insects along at least one surface of said substrate; wherein, i) the weight (wt) of fumed silica to volume (vol) of solvent is less than 15% wt/vol; and ii) said substrate is not glass; and b) permitting the solvent of the applied suspension to evaporate and thereby form a dry coating that forms said passive barrier wherein said dry coating has an incline of at least 20 degrees to the horizontal plane when said article of manufacture is sited for its intended use.

In practice of the methods of this invention, the fumed silica is suspended in a solvent such that the suspension that is formed can be applied to a surface to form a dry coating that forms the passive barrier. As noted in the introduction, some coatings have been found useful for creating insect barriers, but only when applied at a concentration of greater or equal to 15% weight of active ingredient to volume of solvent (15% wt/vol). Applicants have observed that, contrary to these teachings, it is possible to form passive barriers where a dry coating of fumed silica is created from a suspension containing less than 15% wt/vol of fumed silica to solvent. Thus, in practice of some method embodiments of this invention, the weight of fumed silica to volume of solvent is less than 10% wt/vol, less than 7.5% wt/vol, less than 5% wt/vol or less than 2% wt/vol.

The difficulty experienced by an insect attempting to traverse a passive barrier can be affected by the angle of incline that insect must encounter to cross said barrier. In general, the greater the angle of incline, the greater the influence of gravity on the insect and hence, an accompanying increase in the degree of difficulty. By ‘sited for its intended use’ we mean that when the article of manufacture is located for its intended use, the passive barrier formed by the dry coating will be at an incline to the horizontal plane, thereby causing gravity to assist in disruption of the crawling insects' ability to traverse the passive barrier. In some embodiments of practice of the methods described above, said incline referred to in the above described methods is greater than 35 degrees to the horizontal plane, is greater than 45 degrees to the horizontal plane, is greater than 60 degrees to the horizontal plane, is greater than 70 degrees to the horizontal plane or is greater than 80 degrees to the horizontal plane. For clarity, an angle cannot exceed 180 degrees because that angle is parallel to the horizontal plane.

In practice of some embodiments of the above described methods, said substrate can be concrete, wood, paint, metal, ceramic, paper, cardboard, tree bark, particle board, rubber, polytetrafluoroethylene, stone, fabric, nylon, stucco, plaster, drywall composite or a combination of any two or more of the foregoing. In some embodiments, the substrate can be plastic or a combination of plastic and one or more of concrete, wood, paint, metal, ceramic, paper, cardboard, tree bark, particle board, rubber, polytetrafluoroethylene, stone, fabric, nylon, stucco, plaster and/or drywall composite.

In practice of some embodiments of the above described methods, said solvent can be water, ethanol, methanol, isopropanol, acetone, cyclohexane, toluene, methyl acetate, methyl ethyl ketone, ethyl acetate, mineral spirits or a combination of any two or more of the foregoing.

Practice of the above described methods includes use of a fumed silica. Fumed silicas are defined primarily into two classifications related to their surface chemical properties either, hydrophobic or hydrophilic. A non-comprehensive list of examples of hydrophobic silicas include Aerosil R208, Aerosil R104, Aerosil R202, Aerosil R805 and hydrophilic silicas include Aerosil 130, Aerosil 200, Aerosil 255 and Aerosil 300. The Aerosil products are produced by Evonik. Fumed silicas are also available from Cabot.

In practice of some embodiments of the above described methods, said fumed silica suspended in a solvent can be used to create a passive barrier that is hydrophobic or superhydrophobic.

This invention can be applied to articles of manufacture in a manner that prohibits a crawling insect from activities that could otherwise be a nuisance. In some embodiments, a substrate is formed into an article of manufacture and then coated with a coating that forms the passive barrier to insects. In practice of some embodiments of the above described method, said substrate can be formed into an article of manufacture selected from the group consisting of for example: a pet food bowl, a pet food container, a kitchen cupboard, a trash receptacle, a garbage receptacle, a foundation of a structure, a bee hive, a bird feeder, a plate, a bowl or a pedestal suitable for cake, cupcakes or other food items. In some embodiments, the coating formulation that forms the passive barrier is applied after the article of manufacture is created.

The above described methods apply to crawling insects, arachnids and myriapods. Specifically described methods apply to members of the Insecta class, Arachnid class or Myriapod subphylum families of animals. For this discussion, these are all termed “crawling insects”, at least during any stage of life where the primary mode of locomotion of the insect is crawling. In general, said crawling insect can be any crawling insect that is a pest to a home, industry or agriculture. In practice of some embodiments of the above described method, said crawling insect can be an ant (leaf eater, Argentine, carpenter, pharaoh, fire), a spider, a cockroach, a bed bug, termites, an aphid, an arthropod, a tick, a flea, a silver fish, a thrip, a gnat, an aphid, a Japanese beetle, a beetle (potato and bean), a flea beetle, a fleahopper, a squash bug, a slug, a leaf hopper, a harlequin bug, a milk weed bug, a mite, a louse (lice), a scorpion, a millipede, a centipede or a gypsy moth.

As noted above, this invention also pertains to articles of manufacture that comprise a passive barrier formed by application of a suspension of fumed silica suspended in a solvent (in some places herein, this is referred to as a ‘coating formulation’). More specifically, in some embodiments, this invention is directed to an article of manufacture comprising a passive barrier to the passage of crawling insects formed by applying fumed silica to a substrate wherein said substrate has an incline of at least 20 degrees to the horizontal plane when said article of manufacture is sited for its intended use and said substrate is not glass.

In some embodiments, the article of manufacture is formed by applying a suspension of fumed silica in a solvent to said substrate wherein, i) the weight (wt) of fumed silica to volume (vol) of solvent is less than 15% wt/vol, less than 10% wt/vol, less than 7.5% wt/vol, less than 5% wt/vol or less than 2% wt/vol.

In some embodiments of said article of manufacture, said substrate can be concrete, wood, paint, metal, ceramic, paper, cardboard, tree bark, particle board, rubber, polytetrafluoroethylene, stone, fabric, nylon, stucco, plaster, drywall composite or a combination of any two or more of the foregoing. In some embodiments, the substrate can be plastic or a combination of plastic and one or more of concrete, wood, paint, metal, ceramic, paper, cardboard, tree bark, particle board, rubber, polytetrafluoroethylene, stone, fabric, nylon, stucco, plaster and/or drywall composite.

In some embodiments, said article of manufacture can be a pet food bowl, a pet food container, a kitchen cupboard, a trash receptacle, a garbage receptacle, a foundation of a structure, a bee hive, a bird feeder, a plate, a bowl or a pedestal suitable for cake, cupcakes or other food item.

In some embodiments, this invention pertains to a method comprising: a) coating a surface of a substrate with a water-soluble molecule; and b) covering said water-soluble molecule coated surface with a passive barrier to the passage of crawling insects comprising forming a dry coating on said substrate by applying a suspension of fumed silica in a solvent to said substrate. In some embodiments, the method further comprises: c) arranging said substrate such that the coating has an incline of at least 20 degrees to the horizontal plane. In some embodiments, the water-soluble molecule is an insecticide or a pesticide. In some embodiments, the weight (wt) of fumed silica to volume (vol) of solvent is less than 15% wt/vol. In some embodiments, said substrate is not glass. In some embodiments, said substrate is not plastic. In some embodiments, said substrate is the foundation of a structure (e.g. a shed, house or commercial building). When the water-soluble insecticide is applied to the foundation of a structure, the passive barrier coating can assist in minimizing and/or preventing the insecticide/pesticide from leaching into rainwater and contaminating the watershed. In some embodiments, the substrate is plastic, concrete, wood, paint, metal, ceramic, paper, cardboard, tree bark, particle board, rubber, polytetrafluoroethylene, stone, fabric, nylon, stucco, plaster, drywall composite or a combination of any two or more of the foregoing.

In some embodiments, this invention pertains to a substrate comprising: a) a section of a surface coated with a water-soluble insecticide or pesticide; and b) a passive barrier to the passage of crawling insects comprising forming a dry coating on said substrate by applying, over at least a portion of the surface coated with the water-soluble insecticide or insecticide, a suspension of fumed silica in a solvent to said substrate. In some embodiments, said substrate is the foundation of a structure (e.g. a shed, house or commercial building). In some embodiments, the substrate is plastic, concrete, wood, paint, metal, ceramic, paper, cardboard, tree bark, particle board, rubber, polytetrafluoroethylene, stone, fabric, nylon, stucco, plaster, drywall composite or a combination of any two or more of the foregoing.

### 6. EXAMPLES

### Insect Repellent Coatings/Insect Non-Stick Coatings

Aspects of the present teachings can be further understood in light of the following examples, which should not be construed as limiting the scope of the present teachings in any way.

### Example 1

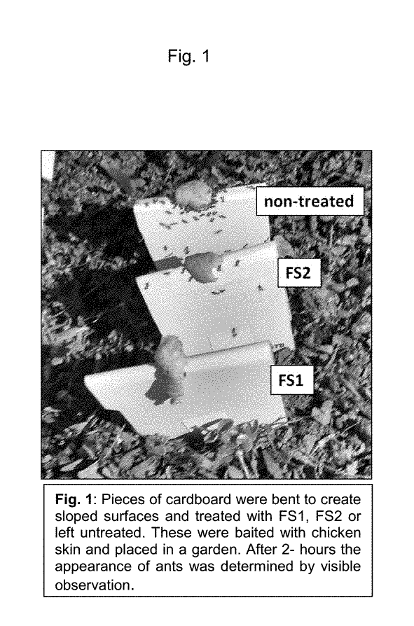

Two different fumed silica formulations were created by mixing either R208 fumed silica (Evonik Corporation) at 2 wt % in acetone (FS1) or at 2 wt % in cyclohexane combined with 1.5 wt % polymer binder (FS2). These formulations were then sprayed onto cardboard that had been bent to create an approximately 80-degree incline. After drying, both the FS1 and FS2 coated cardboard samples were water repellent and had water contact angles of greater than 140°. These samples were placed outdoors in a garden, baited with chicken skin, and ant interaction determined after a few hours. The ants, as seen as little black dots, could readily traverse the non-coated (non-treated) and FS2 coated materials and get to the bait (FIG. 1). There were, however, no ants on the FS1 coated materials (black blemishes on chicken skin are not ants). These samples were left for 14 hours and there were still no ants on the FS1 coated substrates, whereas, dozens of ants gathered on the bait on both the FS2 and non-treated cardboard samples. On both the FS2 and non-treated cardboard samples a typical ant trail up the surfaces to the bait was also seen. It was observed in “real-time” that when ants tried to crawl up the FS1 surface they almost immediately “slipped” off. If ants were placed onto the FS1 coated materials, when they were held flat, and then the cardboard substrate was tilted the ants immediately slid off the surface. This contrasts with FS2 and non-treated surfaces where the ants adhere even when the material is tilted to greater than 90 degrees from the horizontal (for example, upside down).

These results indicate that FS1 can be applied to cardboard surfaces to keep species of ants and perhaps other crawling insects from crawling on inclined surfaces, thereby providing a means to protect the food from infestation.

### Example 2

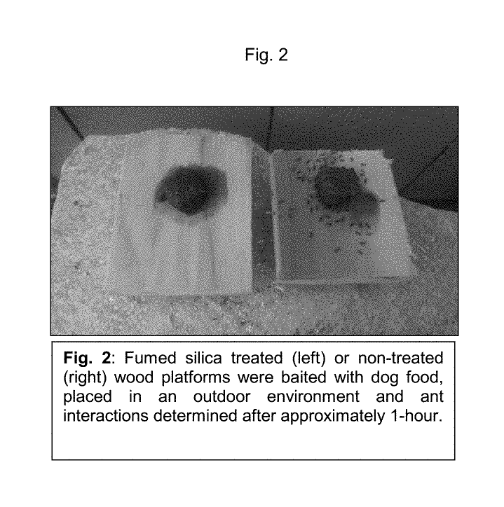

To determine whether the fumed silica dispersion, FS1, described in Example 1, can be used as a barrier to ants, and more generally crawling insects, on other types of surfaces, it was applied by spraying onto the bottom side of a wood platform (including the wood pedestals not seen in the picture). This resulted in a 90-degree inclined wood surface for the insects to traverse to reach the bait. The treated and non-treated wood platforms, baited with dog food, were placed outdoors in the garden. After one-hour the possible appearance of ants on these different surfaces was assessed. The results shown in FIG. 2 demonstrate that ants cannot traverse across the fumed silica dispersion coated wood platform but do so readily on the non-treated surface. Even when these samples are left for greater than 14 hours there are no ants or other insects on the treated wooden platform. These results demonstrate the effectiveness of the fumed silica coating to create a barrier to ants or crawling insects on a roughened wooden surface.

### Example 3

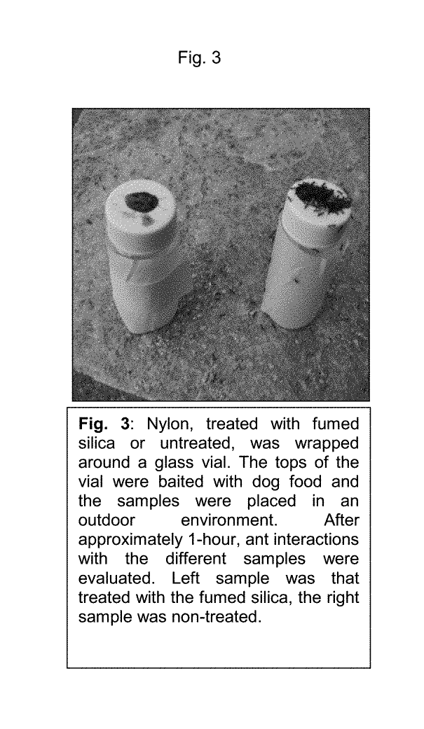

Woven nylon was either treated with the fumed silica dispersion (FS1) of Example 1 or left non-treated. The nylon sheets were then wrapped around a glass vial to create a 90-degree incline, to the horizontal. The samples were placed outdoors and the tops of the vials baited with dog food. After approximately 1-hour the appearance of ants at the bait location was assessed. The results shown in FIG. 3 demonstrate that the fumed silica treatment on the woven nylon surface forms an effective barrier to ants.

### Example 4

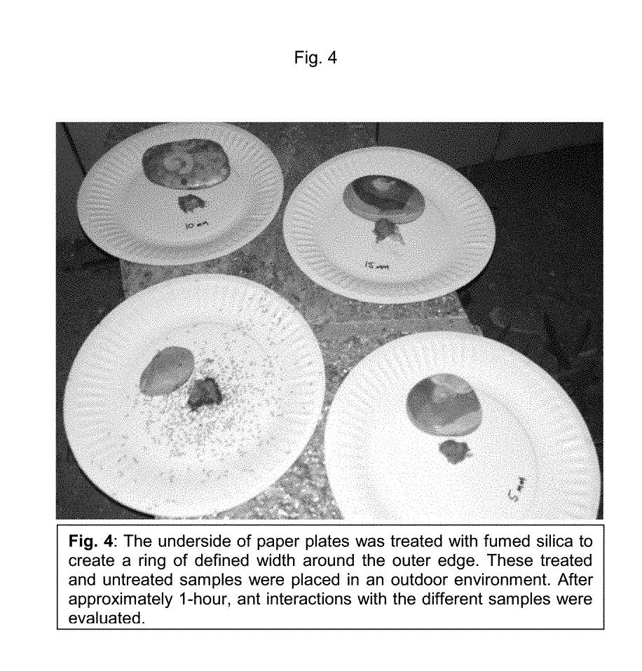

The underside of paper plates was coated with the fumed silica dispersion, FS1, described in Example 1. A stencil was used to mask the bottom so that the applied coating formed a ring around the outer edge of the plate with defined width. Three different widths of coating were applied around the edges of plates to form rings that were 5 mm, 10 mm and 15 mm in width. The angle of inclination for the insects to traverse was approximately 135 degrees to the horizontal. The plates were baited with dog food and placed outdoors. After approximately one hour there were hundreds of ants gathering on the bait on the non-treated paper plate. There were no ants detected on the fumed silica treated plates (FIG. 4). These results demonstrate the effectiveness of the coating on paper surfaces.

### Example 5

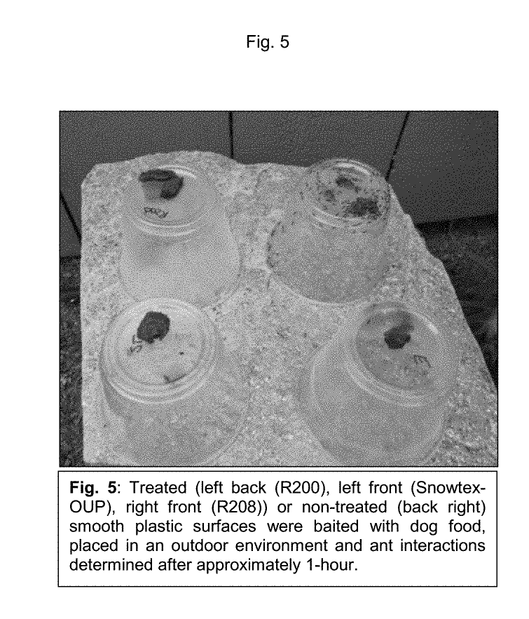

In order to determine whether other silica or fumed silica coatings could form a barrier on inclined smooth surfaces we formulated dispersions of hydrophilic silica (Snowtex-OUP, Nissan Chemical; 3 wt %) or hydrophilic fumed silica (R200; 2 wt % Evonik Corporation) in water containing 0.1° A volume Triton X100 surfactant. These formulations were sprayed onto the outside of plastic cups whose outer surfaces were at an approximately 85-degree incline to the horizontal. The outside of another plastic cup was coated with the fumed silica dispersion FS1, described in Example 1. These samples were then baited with dog food and placed outdoors. Ant interactions were assessed after approximately one hour. These results show that each of the silica dispersions could form a barrier to ants at this angle of inclination on the smooth plastic surface (FIG. 5).

### Example 6

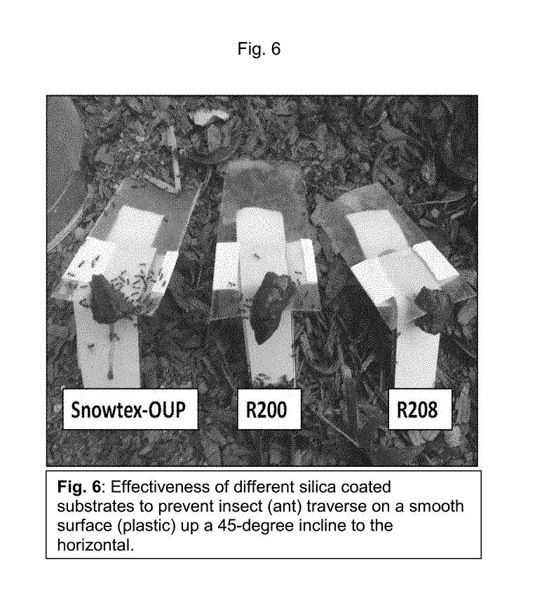

To determine whether the functional performance effectiveness of each of the different silica coatings is similar, a series of plastic substrates were prepared that had a lower angle of incline to the horizontal. Plastic substrates were affixed to cardboard supports at an angle of approximately 45-degree incline to the horizontal. The cardboard surfaces were coated with the FS1 dispersion described in Example 1 to prevent the insects from using that route to get to the bait. The plastic substrates were then spray coated with the R200, Snowtex-OUP or R208 dispersions and after drying were placed outdoors. After approximately 1-hour ant interactions were assessed. The results shown in FIG. 6 demonstrate that at a 45-degree inclination to the horizontal the ants are able to traverse the R200 and Snowtex-OUP coated samples but could not crawl on the hydrophobic R208 coated substrates. These results support the conclusion that the hydrophobic fumed silica coated surfaces may be more effective barrier to some types of crawling insects (e.g. ants) than surfaces coated with hydrophilic silicas.

### Example 7

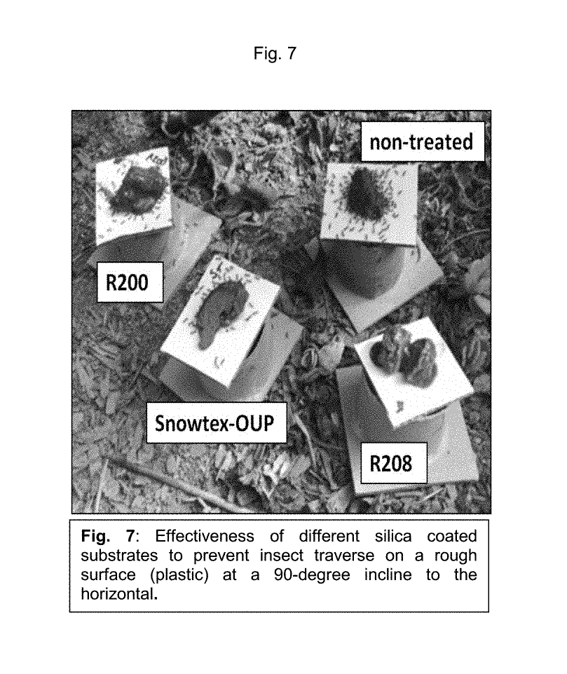

Previous results have demonstrated that PTFE particle dispersions could be used to form barriers to crawling insects (Long) on smooth surfaces, like the plastic shown in FIG. 5, at greater than 15 wt %. This coating, however, was ineffective on “rough” surfaces like wood, cardboard or woven nylon (Examples 1, 2 and 3). To determine whether the hydrophilic silica coatings could be effective as an insect barrier on rough surfaces we prepared cardboard substrates at a 90-degree incline to the horizontal. The coated samples and non-treated control were baited with dog food, placed outdoors and ant interaction assessed after approximately 1 hour. The hydrophobic silicas did not prevent the insects from getting to the bait (FIG. 7). The only effective barrier on this rough substrate was the hydrophobic fumed silica dispersion, FS1, described in Example 1. This further supports the conclusion that the most effective barrier to insects crawling on an inclined surface is formed by deposition of hydrophobic fumed silica dispersion formulated at less than 15 wt % in a solvent.

### Example 8

We have modified the coating formulation by altering the total weight percent of the hydrophobic fumed silica or by creating the coating dispersion in different types of solvents. These formulations were spray coated onto plastic substrates that were prepared to have an 85-degree incline to the horizontal. The coated samples and non-treated control were baited with dog food, placed outdoors and ant interaction assessed after approximately 1 hour. The results are shown in Table 1. The fumed silica formulated at 1, 2 or 5% were all effective to prevent the ants from reaching the bait. This demonstrates coating performance to prevent crawling insects from traversing the inclined barrier over a range of solid concentrations. Additionally, the fumed hydrophobic silica coating formulation can be prepared using a variety of different solvents with no effect on performance. Isopropanol, cyclohexane and parachlorobenzotrifluoride were each used to prepare a 2 wt/vol% coating formulation, which when spray coated onto plastic substrate at an 85-degree angle to the horizontal prevented ants from reaching the bait.

TABLE 1

| solvent | solid | wt/vol % | ants on bait |
|---|---|---|---|
| acetone | none | N/A | yes |
| acetone | R208 | 1 | no |
| acetone | R208 | 2 | no |
| acetone | R208 | 5 | no |
| isopropanol | R208 | 2 | no |
| cyclohexane | R208 | 2 | no |
| parachlorobenzo | R208 | 2 | no |
| trifluoride | | | |

### Example 9

This example was designed to demonstrate that the insect barrier coating can also minimize or prevent extraction (removal or leaching) of a water-soluble molecule such as a dye or insecticide from a surface. A water-soluble dye solution was placed on two different aluminum panels and allowed to air dry. Images of the dried dye spots are shown in Panels A and B of FIG. 8. The dried dye in Panel A was left untreated and the dye in Panel B was spray coated with the insect barrier coating. After complete drying of the insect barrier coating, each panel was sprayed with a jet of water in an attempt to extract the dye from the surface. Most of the dye is washed from the non-coated surface (Panel C, FIG. 8), whereas, no detectable amount is extracted from the surface treated with the insect barrier coating (Panel D, FIG. 8). In some embodiments, the insect barrier coating is hydrophobic or superhydrophobic.

It should be apparent that the water-soluble molecule can be any water-soluble molecule whose presence on the substrate adds value. For example, the water-soluble molecule can be an insecticide or pesticide wherein the insect barrier coating prevents (or at least minimizes) leaching of the insecticide or pesticide from the surface without significant reduction in the effectiveness of the insecticide/pesticide as an effective pest control. By minimizes leaching, we mean that insecticide or pesticide present in the leachate is reduced by at least 50% (more preferably 75% and most preferably by 90%) over a period of at least one week as compared with an untreated (i.e. not coated) surface.

### Example 10

As an alternative to direct application of the insect barrier coating on the substrate, it may be advantageous to apply the coating to a piece of tape, film or other substrate, which will be affixed to the intended location to create an insect barrier. To determine whether the fumed silica dispersion, FS1, described in Example 1, can be used as a barrier to ants, and more generally crawling insects, when applied on polyvinylidene film, it was applied by spraying onto the side of a glass vial that was pre-wrapped with a polyvinylidene film. This resulted in a 90-degree inclined polyvinylidene film surface for the insects to traverse to reach the bait. The treated and non-treated polyvinylidene film, baited with dog food, were placed outdoors in the garden. After one-hour the possible appearance of ants on these different surfaces was assessed. The results shown in FIG. 9 demonstrate that the ants readily traverse the non-treated film to reach the bait while no ants are detected on the polyvinylidene film treated with the coating (FIG. 9).

### Example 11

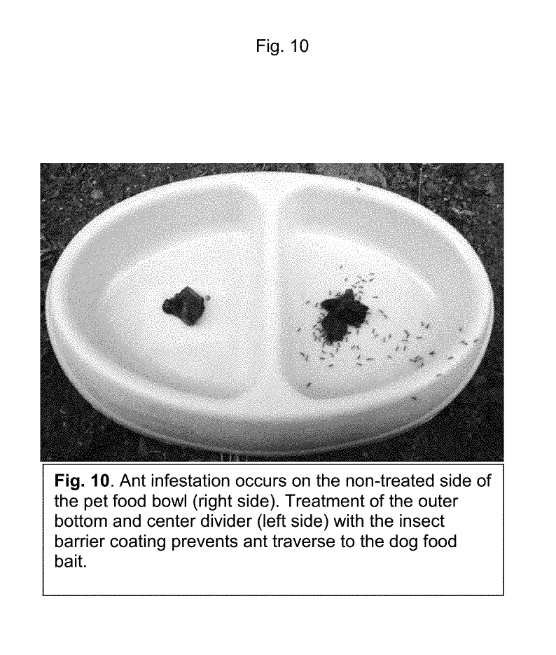

To determine whether ants can reach baits which were placed in the bottom of two compartments in a plastic dog bowl, the outer bottom side and center divider of one compartment was treated with the fumed silica dispersion (FS1) of Example 1 and the other compartment was left non-treated. The samples were placed outdoors. After approximately one hour the appearance of ants at the bait location was assessed. The results shown in FIG. 10 demonstrate that the fumed silica (in solvent) treatment applied on the outer bottom and center divider surface on the treated side of the pet bowl forms an effective passive barrier to ants.

### 7. REFERENCES

US Patent and Published Patent Applications:

| Ref No | Description |
|---|---|
| 1 | U.S. Pat. No. 4,263,740 to Hemsarth et al., issued Apr. 28, 1981 |
| 2 | U.S. Pat. No. 4,423,564 to Davies et al., issued Jan. 3, 1984 |
| 3 | U.S. Pat. No. 4,874,611 to Wilson et al., issued Oct. 17, 1989 |
| 4 | U.S. Pat. No. 5,177,107 to Meer et al., issued Jan. 5, 1993 |
| 5 | U.S. Pat. No. 5,392,559 to Long, Roger H., issued Feb. 28, 1995 |
| 6 | U.S. Pat. No. 5,414,954 to Long, Roger H., issued May 16, 1995 |
| 7 | U.S. Pat. No. 5,557,879 to Ott, Russell J., issued Sep. 24, 1996 |
| 8 | U.S. Pat. No. 5,561,941 to Long, Roger H., issued Oct. 8, 1996 |
| 9 | U.S. Pat. No. 5,566,500 to Long, Roger H., issued Oct. 22, 1996 |
| 10 | U.S. Pat. No. 5,589,181 to Bencsits, Franz, issued Dec. 31, 1996 |
| 11 | U.S. Pat. No. 6,125,790 to Breedwell, R., issued Oct. 3, 2000 |
| 12 | U.S. Pat. No. 6,223,463 to Carlson et al., issued May 1, 2001 |
| 13 | U.S. Pat. No. 6,464,995 to Sekutowski et al., issued Oct. 15, 2002 |
| 14 | U.S. Pat. No. 6,553,726 to Roberts, Ernest H., issued Apr. 29, 2003 |
| 15 | U.S. Pat. No. 6,860,229 to Craft, David, issued Mar. 1, 2005 |
| 16 | U.S. Pat. No. 7,219,622 to Powers, W. H., issued May 22, 2007 |
| 17 | U.S. Pat. No. 7,793,461 to Klein, Arnold G., issued Sep. 14, 2010 |
| 18 | U.S. Pat. No. 7,946,230 to Serrano, N., issued May 24, 2011 |
| 19 | U.S. Pat. No. 8,359,784 to Sommer et al., issued Jan. 29, 2013 |
| 20 | U.S. Pat. No. 8,973,300 to Smith et al., issued Mar. 10, 2015 |
| 21 | U.S. Pat. No. 9,144,233 to Snell, Eric, issued Sep. 29, 2015 |
| 22 | U.S. Pat. No. 9,253,973 to McKnight et al., issued Feb. 9, 2016 |
| 23 | US Published Patent Application No. US 2004/0062784 A1 to Huang, Chen- |
| | Hung, published Apr. 1, 2004 |
| 24 | US Published Patent Application No. US 2010/0005713 A1 to Swart, Paul., |
| | published on Jan. 14, 2010 |
| 25 | US Published Patent Application No. US 2015/0366192 A1 to Jenkins, Dennis |
| | Bruce., published on Dec. 24, 2015 |

Other Patent Documents
None

Scientific Publications:

| Ref No | Description |
|---|---|
| 1 | Bullock J. M. R. et al., The effect of surface roughness on claw and adhesive hair |
| | performance in the dock beetle Gastrophysa viridula, Insect Science. 2011, 18 |
| | (3), 298-304 |
| 2 | Gorb, E. et al., Insect attachment on crystalline bioinspired wax surfaces |
| | formed by alkanes of varying chain lengths Beilstein J of Nanotech 2014, 5, |
| | 1031-1041 |
| 3 | Gorb, E. V. et al., Slippery pores: anti-adhesive effect of nanoporous substrates |
| | on the beetle attachment system, J R Soc Interface, 2010, 7 (52), 1571 |
| 4 | Orchard, Michael J., The functional morphology of insect adhesive devices and |
| | its implications for ecology. Dissertation, University of Hull, 2012 |
| 5 | Prüm, B. et al., Plant surfaces with cuticular folds and their replicas: Influence of |
| | microstructuring and surface chemistry on the attachment of a leaf beetle. Acta |
| | Biomaterialia, 2013, 9: 6360-6368 |
| 6 | Simpson et al., Superhydrophobic Materials and Coatings: a review, Reports |
| | on Progress in Physics, 2015, 78, 086501 |
| 7 | Voigt, D. et al., Sexual dimorphism in the attachment ability of the Colorado |
| | potato beetle Leptinotarsa decemlineata (Coleoptera: Chrysomelidae) to rough |
| | substrates Journal of Insect Physiology 2008, 54 (5), 765-776 |
| 8 | Wolff, J. O. et al., Surface roughness effects on attachment ability of the spider |
| | Philodromus dispar (Araneae, Philodromidae), Journal of Exp Bio, 2012, 215 |
| | (1), 179-184 |
| 9 | Zhou, Y. M. et al., Insect adhesion on rough surfaces: analysis of adhesive |
| | contact of smooth and hairy pads on transparent microstructured substrates J R |
| | Soc Interface. 2014; 11(98): 20140499. |

While the present teachings are described in conjunction with various embodiments, it is not intended that the present teachings be limited to such embodiments. On the contrary, the present teachings encompass various alternatives, modifications and equivalents, as will be appreciated by those of skill in the art. Thus, the invention as contemplated by applicants extends to all functionally equivalent structures, methods and uses, such as are within the scope of the appended claims.

Moreover, in the following claims it should be understood that the order of steps or order for performing certain actions (e.g. mixing of reactants) is immaterial so long as the present teachings remain operable. Unless expressly stated otherwise or where performing the steps of a claim in a certain order would be non-operative, the steps and/or substeps of the following claims can be executed in any order. Moreover, two or more steps or actions can be conducted simultaneously.

I/We claim:

1. A method comprising:
a) creating a passive barrier to the passage of crawling insects comprising forming a dry coating on a substrate by applying a suspension of fumed silica in a solvent to said substrate; wherein, i) the weight (wt) of fumed silica to volume (vol) of solvent is less than 15% wt/vol; and ii) said substrate is not glass; and
b) arranging said substrate such that the coating has an incline of at least 20 degrees to the horizontal plane.

2. The method of claim 1, wherein the weight of fumed silica to volume of solvent is less than 10% wt/vol, less than 7.5% wt/vol, less than 5% wt/vol or less than 2% wt/vol.

3. The method of claim 1, wherein said incline is greater than 35 degrees to the horizontal plane, is greater than 45 degrees to the horizontal plane, is greater than 60 degrees to the horizontal plane, is greater than 70 degrees to the horizontal plane or is greater than 80 degrees to the horizontal plane.

4. The method of claim 1, wherein said substrate is plastic, concrete, wood, paint, metal, ceramic, paper, cardboard, tree bark, particle board, rubber, polytetrafluoroethylene, stone, fabric, nylon, stucco, plaster, drywall composite or a combination of any two or more of the foregoing.

5. The method of claim 1, wherein said solvent is water, ethanol, methanol, isopropanol, acetone, cyclohexane, toluene, methyl acetate, methyl ethyl ketone, ethyl acetate, mineral spirits or a combination of any two or more of the foregoing.

6. The method of claim 1, wherein the substrate forms an article of manufacture selected from the group consisting of: a pet food bowl, a pet food container, a kitchen cupboard, a trash receptacle, a garbage receptacle, a foundation of a structure, a bee hive, a bird feeder, a plate, a bowl or a pedestal suitable for cake, cupcakes or other food item. The method of claim 1, wherein the crawling insect is an ant (leaf eater, Argentine, carpenter, pharaoh, fire), a spider, a cockroach, a bed bug, termites, an aphid, an arthropod, a ticks, a flea, a silver fish, a thrip, a gnat, an aphid, a Japanese beetle, a beetle (potato and bean), a flea beetle, a fleahopper, a squash bug, a slug, a leaf hopper, a harlequin bug, a milk weed bug, a mite, a louse, a scorpion, a millipede, a centipede or a gypsy moth.

8. A method comprising:
a) applying a suspension comprising fumed silica in a solvent to a substrate of an article of manufacture to form a passive barrier to the passage of crawling insects along at least one surface of said substrate; wherein, i) the weight (wt) of fumed silica to volume (vol) of solvent is less than 15% wt/vol; and ii) said substrate is not glass; and
b) permitting the solvent of the applied suspension to evaporate and thereby form a dry coating that forms said passive barrier wherein said dry coating has an incline of at least 20 degrees to the horizontal plane when said article of manufacture is sited for its intended use.

9. The method of claim 8, wherein the weight of fumed silica to volume of solvent is less than 10% wt/vol, less than 7.5% wt/vol, less than 5% wt/vol or less than 2% wt/vol.

10. The method of claim 8, wherein said incline is greater than 35 degrees to the horizontal plane, is greater than 45 degrees to the horizontal plane, is greater than 60 degrees to the horizontal plane, is greater than 70 degrees to the horizontal plane or is greater than 80 degrees to the horizontal plane.

11. The method of claim 8, wherein said substrate is plastic, concrete, wood, paint, metal, ceramic, paper, cardboard, tree bark, particle board, rubber, polytetrafluoroethylene, stone, fabric, nylon, stucco, plaster, drywall composite or a combination of any two or more of the foregoing.

12. The method of claim 8, wherein said solvent is water, ethanol, methanol, isopropanol, acetone, cyclohexane, toluene, methyl acetate, methyl ethyl ketone, ethyl acetate, mineral spirits or a combination of any two or more of the foregoing.

13. The method of claim 8, wherein said article of manufacture is a pet food bowl, a pet food container, a kitchen cupboard, a trash receptacle, a garbage receptacle, a foundation of a structure, a bee hive, a bird feeder, a plate, a bowl or a pedestal suitable for cake, cupcakes or other food item.

14. The method of claim 8, wherein the crawling insect is an ant (leaf eater, Argentine, carpenter, pharaoh, fire), a spider, a cockroach, a bed bug, termites, an aphid, an arthropod, a ticks, a flea, a silver fish, a thrip, a gnat, an aphid, a Japanese beetle, a beetle (potato and bean), a flea beetle, a fleahopper, a squash bug, a slug, a leaf hopper, a harlequin bug, a milk weed bug, a mite, a louse (lice), a scorpion, a millipede, a centipede or a gypsy moth.

15. An article of manufacture comprising a passive barrier to the passage of crawling insects formed by applying fumed silica to a substrate wherein said substrate has an incline of at least 20 degrees to the horizontal plane when said article of manufacture is sited for its intended use and said substrate is not glass.

16. The article of manufacture of claim 15, wherein the passive barrier is formed by applying a suspension of fumed silica in a solvent to said substrate wherein, i) the weight (wt) of fumed silica to volume (vol) of solvent is less than 15% wt/vol, less than 10% wt/vol, less than 7.5% wt/vol, less than 5% wt/vol or less than 2% wt/vol.

17. The article of manufacture of claim 15, wherein said substrate is plastic, concrete, wood, paint, metal, ceramic, paper, cardboard, tree bark, particle board, rubber, polytetrafluoroethylene, stone, fabric, nylon, stucco, plaster, drywall composite or a combination of any two or more of the foregoing.

18. The article of manufacture of claim 15, wherein said article of manufacture is a pet food bowl, a pet food container, a kitchen cupboard, a trash receptacle, a garbage receptacle, a foundation of a structure, a bee hive, a bird feeder, a plate, a bowl or a pedestal suitable for cake, cupcakes or other food item.

19. A method comprising:
a) coating a surface of a substrate with a water-soluble insecticide or pesticide; and
b) covering said water soluble insecticide or pesticide coated surface with a passive barrier to the passage of crawling insects comprising forming a dry coating on said substrate by applying a suspension of fumed silica in a solvent to said substrate.

20. A substrate comprising:
a) a section of a surface coated with a water-soluble insecticide; and
b) a passive barrier to the passage of crawling insects comprising forming a dry coating on said substrate by applying, over at least a portion of the surface coated with the water-soluble insecticide, a suspension of fumed silica in a solvent to said substrate.
